(19) United States
(12) Patent Application Publication
(10) Pub. No.: US 2026/0352145 A1
(43) Pub. Date: Nov. 5, 2026

(54) SUPPORT STRUCTURES FOR SOLAR TRACKER SYSTEMS WITH UNDER MODULE BEARING SYSTEMS

(71) Applicant: Nextpower LLC, Fremont, CA (US)

(72) Inventor: Tyrus Hudson, Petaluma, CA (US)

(21) Appl. No.: 19/660,356

(22) Filed: Apr. 28, 2026

Related U.S. Application Data
(60) Provisional application No. 63/798,363, filed on May 1, 2025.

(51) Int. Cl. H02S 20/32

(52) U.S. Cl. CPC H02S 20/32

(57) ABSTRACT

A solar tracker support assembly includes a sliding member, a support rail, and a truss adapter. The sliding member is coupled to a torque tube. The support rail includes a receiving bracket, and the sliding member is slidably coupled to the receiving bracket such that the torque tube is slidable relative to the support rail. The truss adapter is configured to couple the support rail to a solar tracker foundation.

### CROSS REFERENCE TO RELATED APPLICATIONS

This application claims the benefit of U.S. Provisional Patent Application No. 63/798,363, filed May 1, 2025, the entire contents of which is hereby incorporated by reference.

### TECHNICAL FIELD

This disclosure relates generally to solar power generation systems, and more particularly, to support structures for solar arrays within a solar tracking system

### BACKGROUND

Solar panels can convert sunlight into energy. As an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Solar panels are generally composed of an array of solar cells, which are interconnected to each other. The cells are often arranged in series and/or parallel groups of cells in series. Accordingly, solar panels have great potential to benefit our nation, security, and human users. They can even diversify our energy requirements and reduce the world's dependence on oil and other potentially detrimental sources of energy.

Solar tracking systems can be used to dynamically orient a plurality of solar modules, for instance, by moving the solar modules throughout the course of a given day to track the movement of the sun and thereby increase the efficiency and productivity of the solar modules. However, because solar tracking systems apply motive force to move the solar modules, resulting forces can be imparted on the piles that support the movable solar modules. In addition, the solar modules can experience natural forces in the field, such as wind loads, which can create additional acting forces on the piles that support the movable solar modules.

Further, during operation of the solar tracker, thermal fluctuations occur daily and seasonably resulting in thermal expansion and contraction of the solar tracker components. In many instances, thermal expansion is not significant enough to impart noticeable forces on the components. However, the torque tubes of the solar trackers can span significant lengths, which results in noticeable expansion and contraction during daily and seasonal temperature fluctuations.

The thermal expansion and contraction of torque tubes can impart significant loads on the couplings and the piers supporting them. Axial forces due to expansion and contraction of the torque tube can cause the piers to deflect or otherwise deform to accommodate this axial movement by the torque tube. This deflection by the piers can cause misalignment of the couplings with respect to the torque tubes, which can cause increased friction or binding of the torque tube as the torque tube is rotated within the couplings. This binding or increased friction increases the amount of force required to rotate the torque tube, which in turn, imparts increased load on the actuators or motors effectuating the rotation, and in some instances can cause the torque tube to twist along its length, causing some solar panels to rotate more or less than other solar panels along the length of the torque tube. The present disclosure seeks to address the shortcomings of prior tracker systems.

### SUMMARY

In general, the present disclosure relates to support structures for solar arrays within a solar tracking system. In one example, a solar tracker support assembly may include a sliding member coupled to a torque tube, a support rail comprising a receiving bracket, the sliding member slidably coupled to the receiving bracket such that the torque tube is slidable relative to the support rail, and a truss adapter configured to couple the support rail to a solar tracker foundation.

Additionally or alternatively, the coupling of the sliding member and the receiving bracket may slidingly and rotationally supports the torque tube relative to the truss adapter.

Additionally or alternatively, the support rail may be rotationally coupled to the truss adapter such that the support rail is rotatable with the torque tube relative to the truss adapter.

Additionally or alternatively, the torque tube may be configured to support one or more solar modules at a first side of the torque tube, and wherein the sliding member, support rail, and receiving bracket are each located at least opposite the first side of the torque tube.

Additionally or alternatively, the torque tube may be rotatable relative to truss adapter about a rotational axis that is different than a central longitudinal axis of the torque tube.

Additionally or alternatively, the coupling of the sliding member and the receiving bracket slidingly may support the torque tube relative to the truss adapter such that the torque tube can slide relative to the truss adapter in a north-south direction.

Additionally or alternatively, the truss adapter may comprise one or more rollers, the support rail may comprise one or more roller guides, and the truss adapter may rotatably support the support rail to rotate relative to the truss adapter via engagement of the one or more rollers at the one or more roller guides.

Additionally or alternatively, the support rail may be rotatable relative to the truss adapter in an arcuate path in an east-west direction.

Additionally or alternatively, the support rail may be configured to rotate relative to the truss adapter in the arcuate path in an east direction until the support rail contacts a first stop at the truss adapter, and wherein the support rail is configured to rotate relative to the truss adapter in the arcuate path in a west direction until the support rail contacts a second stop at the truss adapter.

Additionally or alternatively, the coupling of the sliding member and the receiving bracket may slidingly support the torque tube relative to the truss adapter, and the coupling of the sliding member and the receiving bracket may rotationally couple the torque tube to the support rail such that as the torque tube is driven to rotate the support rail rotates with the torque tube in the arcuate path in the east-west direction.

Additionally or alternatively, the sliding member may comprise a first sliding member end portion, a second sliding member end portion, and a protruded sliding member middle portion between the first and second sliding member end portions, the receiving bracket may comprise a first receiving bracket end portion, a second receiving bracket end portion, and a channeled receiving bracket middle portion between the first and second receiving bracket end portions, and the torque tube may be slidably and rotationally coupled to the support rail via engagement of the first sliding member end portion at the first receiving bracket end portion, engagement of the second sliding member end portion at the second receiving bracket end portion, and engagement of the protruded sliding member middle portion at the channeled receiving bracket middle portion.

Additionally or alternatively, the first receiving bracket end portion may extend over the first sliding member end portion, wherein the second receiving bracket end portion extends over the second sliding member end portion, and wherein a protrusion at the protruded sliding member middle portion is received at a channel at the channeled receiving bracket middle portion.

In another example, a solar tracker support assembly may include a first truss leg, a second truss leg, a truss adapter comprising a first connecting portion connected to the first truss leg and a second connecting portion connected to the second truss leg, a cam configured to couple to a torque tube to the truss adapter, a first spring comprising a first spring first end connected to the cam and a first spring second end connected to the first truss leg, and a second spring comprising a second spring first end connected to the cam and a second spring second end connected to the second truss leg.

Additionally or alternatively, the cam may be configured to rotate with the torque tube to orient at least one solar module in an eastward facing orientation, and wherein when the at least one solar module is in the eastward facing orientation the first spring is compressed while the second spring is tensioned.

Additionally or alternatively, the cam may be configured to rotate with the torque tube to orient at least one solar module in a westward facing orientation, and wherein when the at least one solar module is in the westward facing orientation the first spring is tensioned while the second spring is compressed.

Additionally or alternatively, the cam may comprise an asymmetric cross-sectional profile.

Additionally or alternatively, the torque tube may be at least partially received within the cam.

Additionally or alternatively, the first spring first end may be connected to the cam above the torque tube, and wherein the second spring first end may be connected to the cam above the torque tube.

Additionally or alternatively, the first spring first end and the second spring first end may overlap at the cam above the torque tube.

Additionally or alternatively, the asymmetric cross-sectional profile of the cam may be configured to transfer gravitational forces in multiple axes to the first spring and the second spring.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2 is a schematic, top view of a solar tracking system;

FIG. 3 is a front view of a portion of an example solar module supported by an example truss foundation;

FIG. 4A is an example screw anchor usable with various embodiments of the present disclosure;

FIG. 4B is a detailed view of a lead-in thread form of the screw anchor, as in FIG. 4A;

FIG. 5A is a perspective view of an example support rail and a truss adapter, including a torque tube, in accordance with the disclosure;

FIG. 5B is a front-side view of the example support rail and the truss adapter, including the torque tube, as in FIG. 5A;

FIG. 6A is a side-view of the example support rail and the truss adapter, including the torque tube, as in FIG. 5A;

FIG. 6B is an isolated view of the example truss adapter, as in FIG. 5A;

FIG. 7A is an isolated front-side view of the example support rail including the torque tube, as in FIG. 5A;

FIG. 7B is a cross-sectional view of the example support rail including the torque tube, as in FIG. 7A, taken at line 7B-7B;

FIG. 8 is an isolated, bottom-side view of the torque tube, as in FIG. 5A;

FIG. 9 is an isolated, front-side view of the example support rail, as in FIG. 5A;

FIG. 10A is a front-side view of an example truss support including a first spring and a second spring in a first position, in accordance with the disclosure;

FIG. 10B is a front-side view of the example truss support including the first spring and the second spring, as in FIG. 10A, in a second position;

FIG. 10C is a front-side view of the example truss support including the first spring and the second spring, as in FIG. 10A, in a third position;

FIG. 11 is a front, perspective view of the example truss support, as in FIG. 10A, with the first spring and the second spring removed;

FIG. 12 is a front-side view of an example truss support in a first position, in accordance with the disclosure;

FIGS. 13A to 13C illustrate the example truss support, as in FIG. 12, moving to a second position; and

FIGS. 14A to 14C illustrate the example truss support, as in FIG. 12, moving to a third position.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar tracker supports configured to facilitate improved structural stability for solar tracking systems. Certain embodiments disclosed herein can improve solar tracking system structural stability while increasing the efficiency of solar tracking foundation installation and reducing costs (e.g., foundation and/or support material costs) associated with solar tracker foundations and supports.

During operation of solar trackers, thermal fluctuations occur daily and seasonably resulting in thermal expansion and contraction of the solar tracker components. In many instances, thermal expansion is not significant enough to impart noticeable forces on the components. However, the torque tubes of the solar trackers can span significant lengths, which results in noticeable expansion and contraction during daily and seasonal temperature fluctuations.

The thermal expansion and contraction of torque tubes can impart substantial axial loads on the support structures. The torque tubes of the solar tracker are rotatably supported on the piers by a coupling. These couplings enable the torque tube to rotate about its longitudinal axis and in many embodiments, enable the torque tube to axially slide within the coupling to accommodate thermal expansion and contraction of the torque tube. Axial movement of the torque tube can impart significant loads on the couplings and the piers supporting them. Axial forces due to expansion and contraction of the torque tube can cause the piers to deflect or otherwise deform to accommodate this axial movement by the torque tube. This deflection by the piers can cause misalignment of the couplings with respect to the torque tubes, which can cause increased friction or binding of the torque tube as the torque tube is rotated within the couplings. This binding or increased friction increases the amount of force required to rotate the torque tube, which in turn, imparts increased load on the actuators or motors effectuating the rotation, and in some instances can cause the torque tube to twist along its length, causing some solar panels to rotate more or less than other solar panels along the length of the torque tube. Embodiments herein may include support rails and/or truss supports designed to allow for axial movement of the torque tube in a north-south direction, aligning with the length of the torque tube, to accommodate deflection caused by thermal expansion. In such cases, allowing the axial movement of the torque tube in the north-south direction may thereby prevent deformation due to axial forces via thermal expansion placed upon the torque tube.

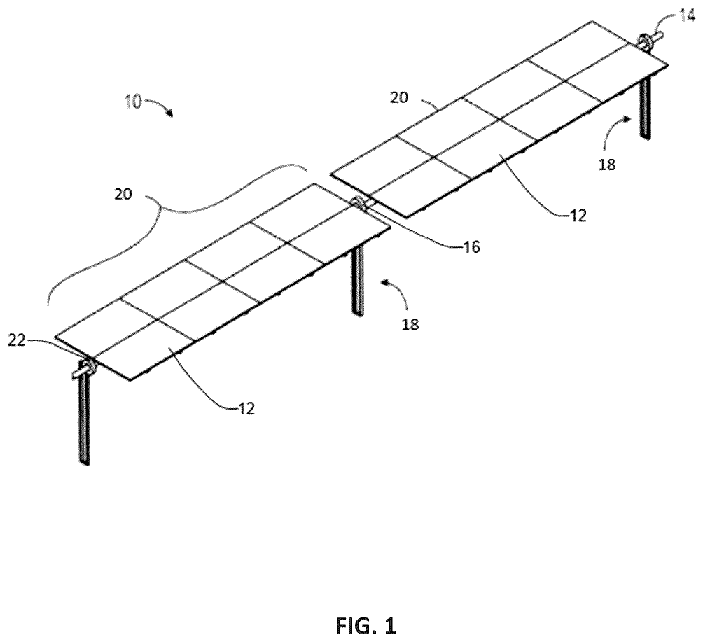

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedment in the ground, such as one for each leg of an A-frame support where the embedments are spaced apart in the east-west direction. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to adapterture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced or substantially eliminated and to absorb torsional loads applied to the torque tube 14 by wind loading. In addition, since there is often just a single drive mechanism 16, the specifications for the torque tube 14 may desire to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

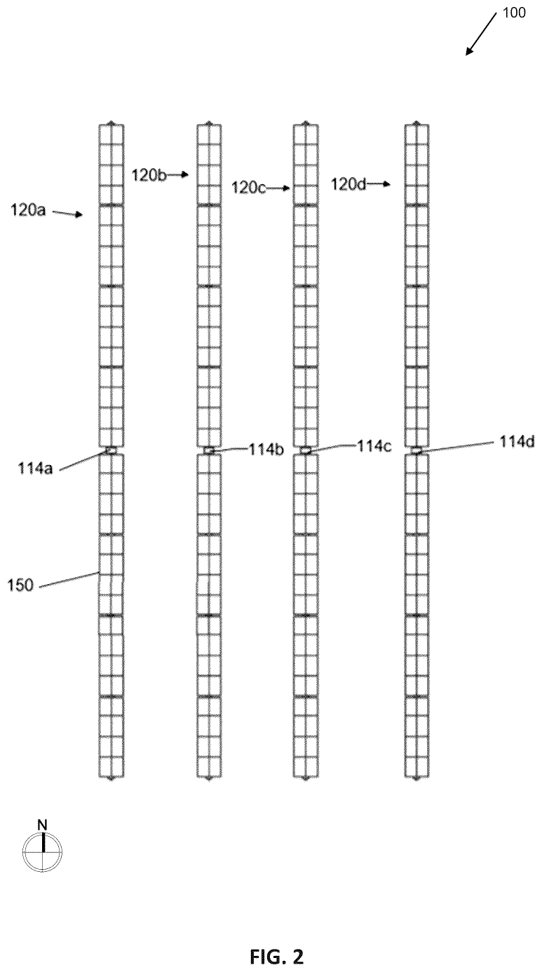

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

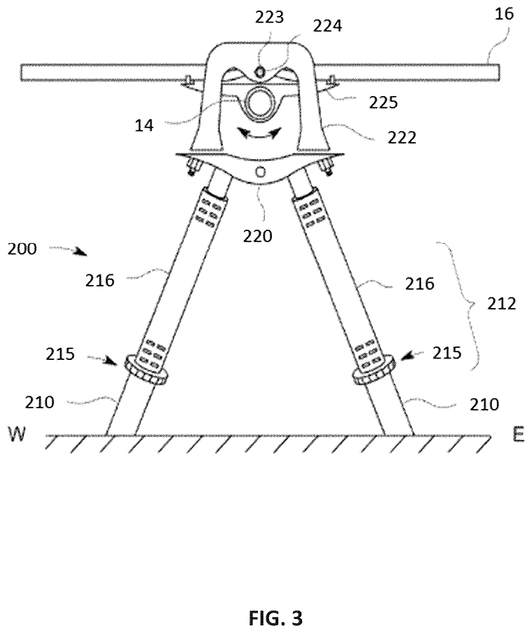

FIG. 3 is a front view of a portion of the solar module 12 supported by an example truss foundation 200. The truss foundation 200 may include a pair of adjacent screw anchors 211 that have been driven into supporting ground at angles to one another on the East and West sides of an intended North-South line of a tracker row. Once anchors 211 reach their target embedment depth, driving stops and truss adapter or adapter 220 is held in place by a jig on the driving machine at the correct location to insure alignment with other truss adapters or adapters in the same row. Then, upper legs 216 are sleeved over driving collars 215 of each anchor and respective connecting portions 221 of the truss adapter 220 to complete each truss leg 212. As shown in FIG. 3, truss adapter 220 provides a pair of spaced-apart pedestals that support the opposing feet of a bearing housing assembly (BHA) 222. As shown, BHA 222 is a cardioid-shaped hoop with bearing 223 proximate to the cusp. It should be appreciated that other variants are possible as long as the bearing location enables the torque tube to be suspended from a bearing pin such that the torque tube rotates about a rotational axis that is different than the torque tube's central longitudinal axis. Bearing pin 224 is received within bearing 223 and extends out of both sides of BHA 222. A torque tube module bracket such as bracket 225 is suspended from either side of bearing pin 224. Brackets 225 support the torque tube 14 and attach to the frame of at least one adjacent photovoltaic module or solar module 12. In this type of tracker system, the drive motor's drive axis is aligned with bearing pin 224 rather than the torque tube 14 so that as the motor's output shaft rotates, the torque tube 14 swings through an arc that is bounded on either side by the BHA 222. This may be accomplished by a bend in the torque tube 14 on both sides of the drive motor.

As shown in the FIG. 3, upper legs 216 are joined to adapters 220 by sleeving the open end of each leg over respective connecting portions protecting away from the adapter. Then, crimps are formed over the overlapping portion of each upper leg 216 to lock the adapters into place. Crimps are also formed at the lower end of each upper leg 216 where it overlaps with the collar 215. In various embodiments, the screw anchor driving machine may include a jig or other device that orients the adapter or truss adapter so that it is level and aligned with a laser line to be at the at the same Y (East-West) position as every other adapter in the current row so that the truss foundation 200 can be constructed in a fast, precise and repeatable manner. In various embodiments, once the adapter or truss adapter 220 has been properly aligned, upper legs 216 may be crimped at each end, that is, at the areas of overlap with screw anchors 211 and with truss adapter or adapter 220, thereby forming a rigid A-frame structure. In various embodiments, assembling the truss foundation 200 at the time the screw anchors are driven will obviate the need for later alignment steps, such as when the tracker components are installed.

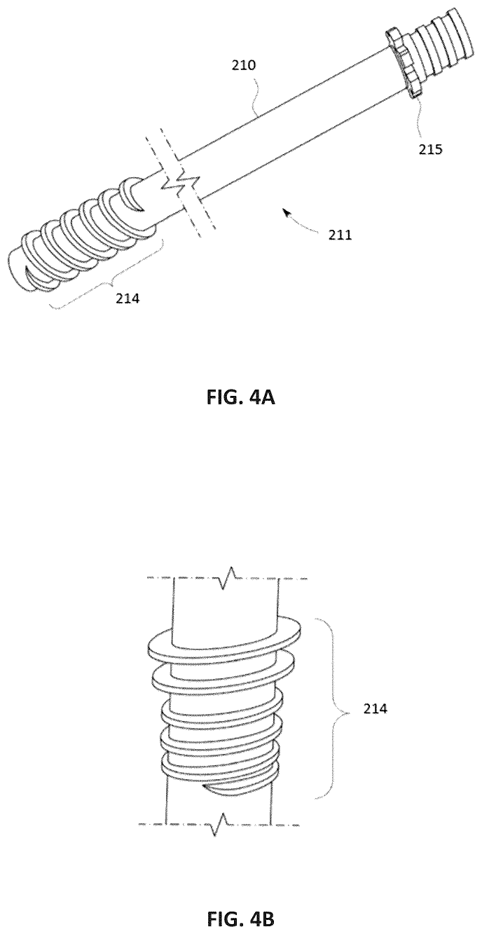

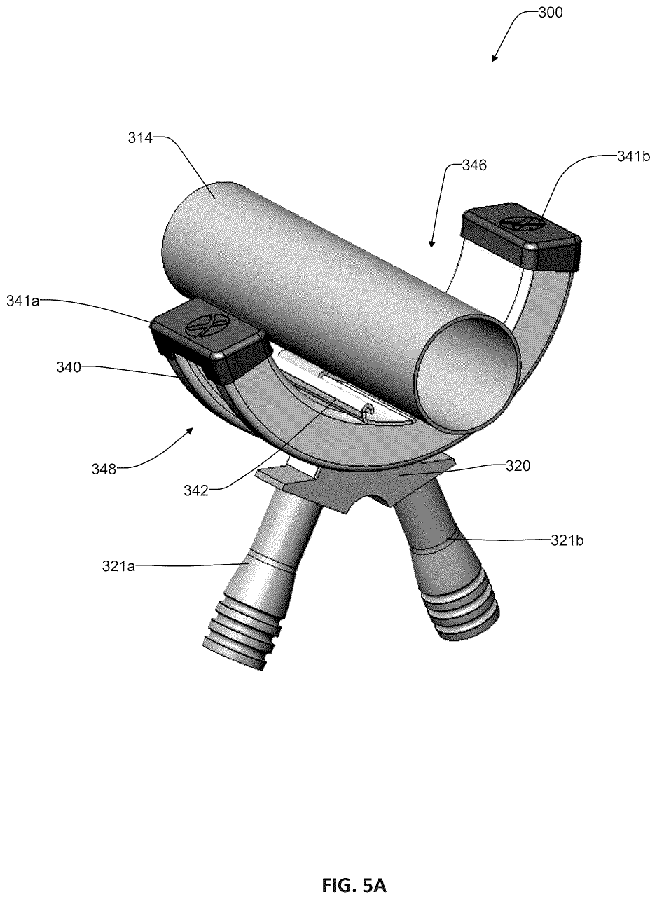

FIG. 4A is an example screw anchor 211 and FIG. 4B is a detailed view of a lead-in thread form 214 of the screw anchor 211, as in FIG. 4A. The screw anchor 211 is shown partially shown in FIG. 3. The screw anchor 211 may consist of a hollow, substantially uniform diameter rounded shaft 210 that is open at both ends with external threads 214 at one end and a driving collar 215 at the other. In various embodiments, threads 214 may have a tapered profile, as seen for example, in FIG. 4B, so that their outside diameter increases moving up the shaft to create a lead-in. A taper such as this may help keep it on path while driving and assist when driving into hard soils, caliche and even rock. The threads may also, in various embodiments, be tilted slightly upwards, that is, towards collar 215 to provide additional resistance to pull out. The length of screw anchor 211 may be variable depending on the desired depth of embedment (e.g., 1-2 meters). In the context of foundations for single-axis trackers and other axial solar arrays, embedment depth may be dictated by soil type, grade of land, torque tube height, and tracker type, among other factors. The inside diameter of the shaft 210 may be between two and half and three inches and the thickness on the order of a few millimeters. It may be formed from galvanized alloy steel or other suitable material. In some cases, it may be coated with one or more additional anti-corrosion coatings such as fusion bonded epoxy, polyurethane, or acrylic, among others. Driving collar 215 may be a separate cast structure welded on to the upper end of shaft 210 or, alternatively, may be stamped, pressed, or otherwise formed in the upper end. Threads 214 may be welded to the outside of shaft 210 at the lower end, may be attached with bent tabs or, in some cases may even be stamped into the lower end. In some cases, the threads 214 may be hydroformed from the shaft 210. The threads 214 may enable the screw anchor 211 be driven into supporting ground with a combination of torque and downforce. The screw anchor's 211 open end allows a drill or other tool to be extended through it while the anchor is being driven into the ground to enable it to go through dense soil, rocks or other strata that might refuse the anchor 211 by itself.

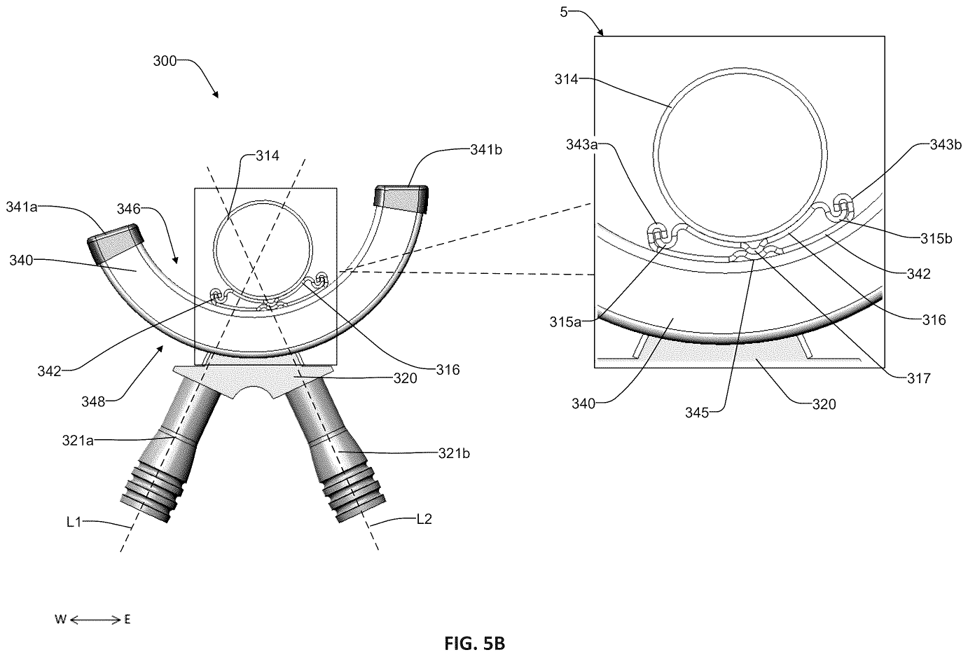

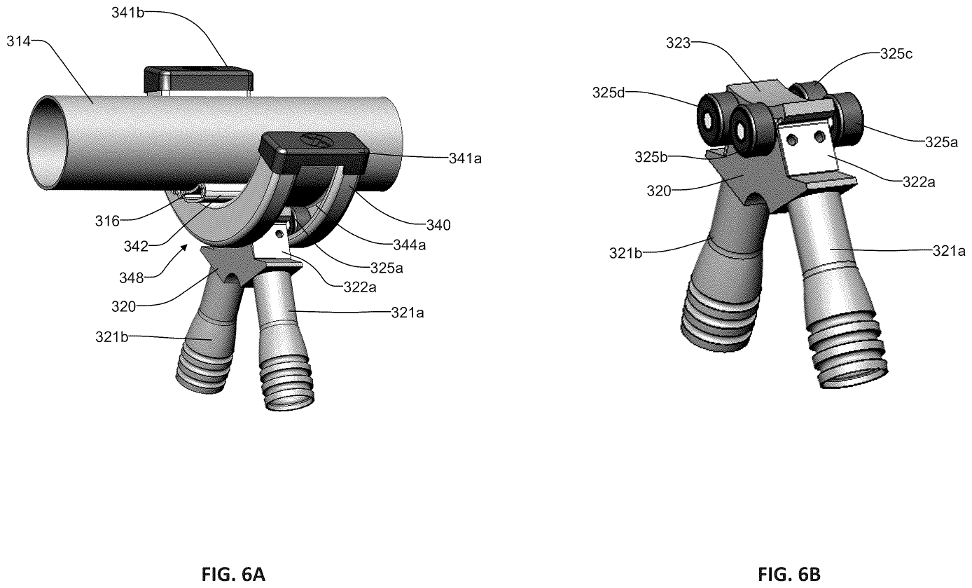

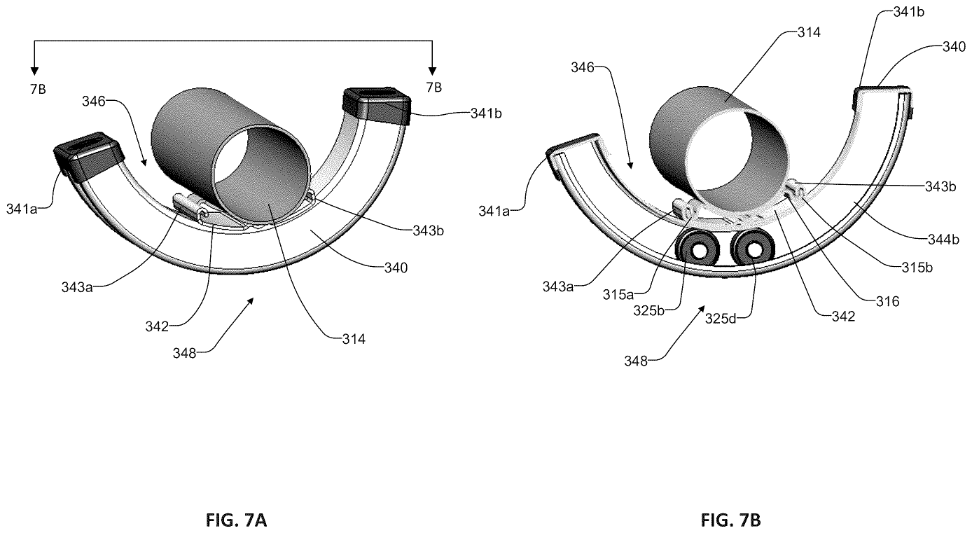

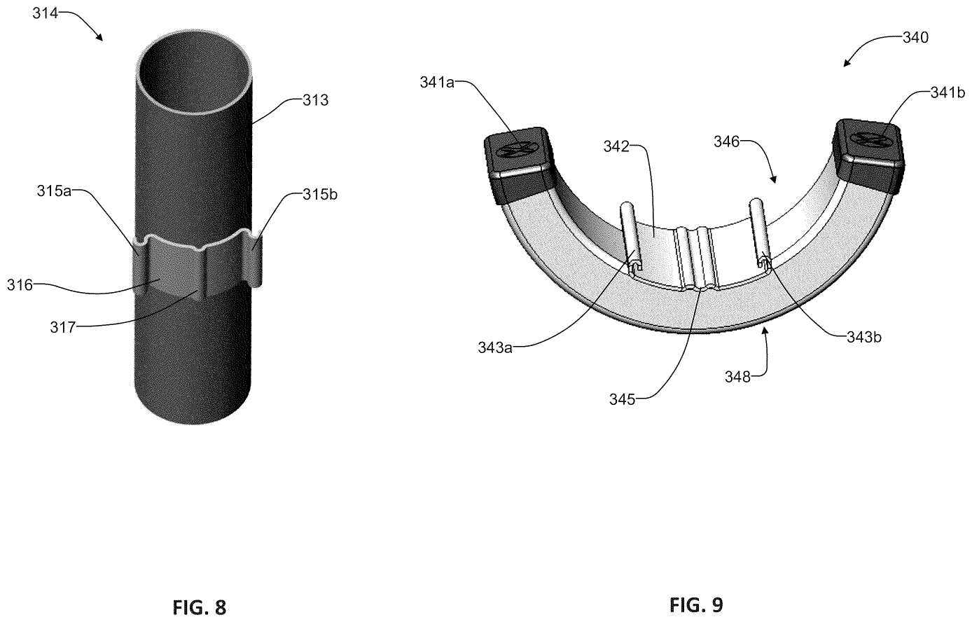

FIG. 5A is a perspective view of an example support rail 300 including a truss adapter 320 and a torque tube 314, and FIG. 5B is a front-side view of the support rail 300 including the truss adapter 320 and the torque tube 314. The support rail 300 may include a curved “U-shape” having a first end 341a and a second end 341b, the first end 341a and the second end 341b defining the “U-shape” therebetween. The support rail 300 may further include a top side 346 and a bottom side 348, opposite the top side 346. The bottom side 348 may be the side that is coupled to the truss adapter 320, as will be discussed further with reference to FIGS. 6A and 6B.

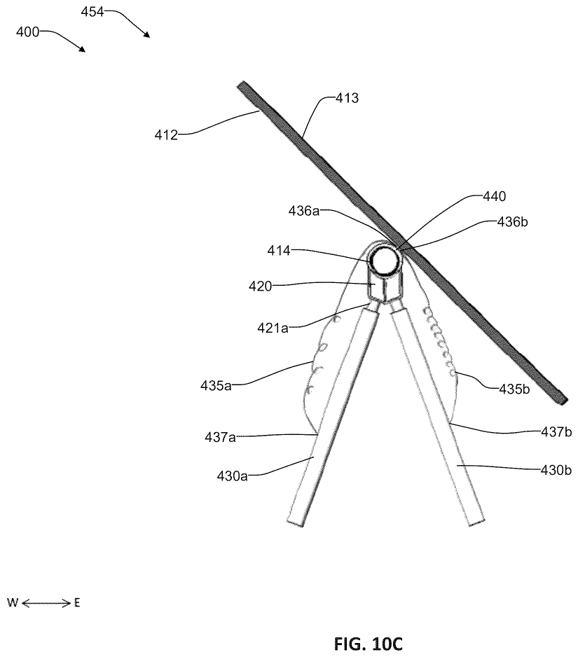

The support rail 300 may be configured to be secured to the torque tube 314 via one or more brackets. In some examples, the torque tube 314 may include a sliding member 316 coupled to an underside 313 of the torque tube 314, as shown in Square 5. The sliding member 316 may include a first end portion 315a, a second end portion 315b, and a middle portion 317 therebetween. The first end portion 315a and the second end portion 315b may each include a hooklike shape which may curve away from the top side 346 of the support rail 300, and the middle portion 317 may include a ridge-like protrusion, as shown in further detail with reference to FIG. 8. The sliding member 316 may be coupled to the torque tube 314 via welding, adhesives, mechanical fasteners, or any other suitable coupling mechanism as desired.

In some examples, a receiving bracket 342 may be coupled to the top side 346 of the support rail 300. The receiving bracket 342 may include a first end portion 343a, a second end portion 343b, and a middle portion 345 therebetween. The first end portion 343a and the second end portion may each include hooklike shape which may curve inward toward the top side 346 of the support rail 300, and the middle portion 345 may include a channel. The receiving bracket 342 may be coupled to the support rail 300 via welding, adhesives, mechanical fasteners, or any other suitable coupling mechanism as desired.

The sliding member 316 may be configured to be coupled to the receiving bracket 342, thereby coupling the torque tube 314 to the support rail 300. In some examples, the first end portion 315a and the second end portion 315b of the sliding member 316 may align with the first end portion 343a and the second end portion 343b of the receiving bracket 342, respectively. Such alignment further aligns the ridge-like protrusion of the middle portion 317 of the sliding member 316 with the channel of the middle portion 345 of the receiving bracket 342. To couple the torque tube 314 to the support rail 300, the sliding member 316 advances into the receiving bracket 342. Advancement of the sliding member 316 into the receiving bracket 342 initiates engagement of the first end portion 343a of the receiving bracket 342 with the first end portion 315a of the sliding member 316, the second end portion 343b of the receiving bracket 342 with the second end portion 315b of the sliding member 316, and the middle portion 345 of the receiving bracket 342 with the middle portion 317 of the sliding member 316. In such examples, the first end portion 343a of the receiving bracket 342 may extend over the first end portion 315a of the sliding member 316, and the second end portion 343b of the receiving bracket 342 may extend over the second end portion 315b of the sliding member 316 in interlocking engagement. Further, the ridge-like protrusion of the middle portion 317 of the sliding member 316 may be configured to fit within the channel of the middle portion 345 of the receiving bracket 342.

The interlocking engagement of the sliding member 316 with the receiving bracket 342 may not only serve to couple the torque tube 314 to the support rail 300 but may further allow for thermal expansion and contraction of the torque tube 314. As previously discussed, thermal expansion and contraction of the torque tube 314 may impart substantial axial loads on support structures (e.g., piers, support rails, etc.) via axial movement of the torque tube 314. The ability to move in a north-south direction via engagement of the sliding member 316 and the receiving bracket 342 may accommodate thermal expansion and contraction of the torque tube 314, thereby minimizing and/or preventing damage to or deformation of support structures.

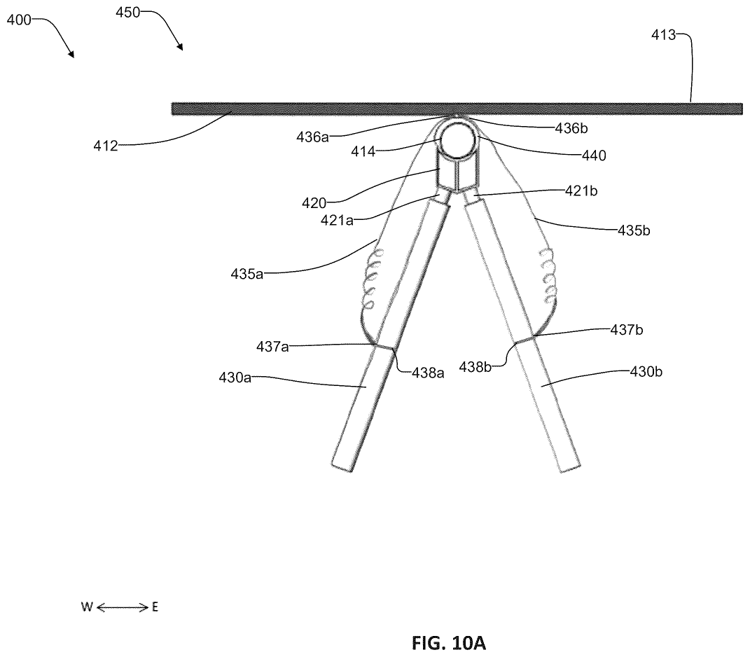

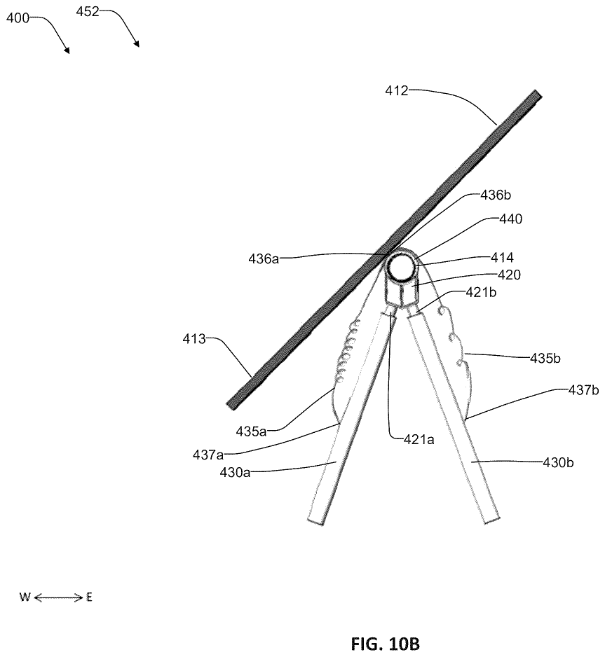

As shown in FIGS. 5A and 5B, the support rail 300 may be coupled to the truss adapter 320. The truss adapter 320 may support the support rail 300 through engagement of one or more rollers of the truss adapter 320 with one or more guides on the bottom side 348 of the support rail 300, as shown further with reference to FIGS. 6A to 7B. The truss adapter 320 may include a first connecting surface 321a and a second connecting surface 321b. The first connecting surface 321a and the second connecting surface 321b may be configured to engage with upper legs of a pier and/or a truss support, although this is not explicitly shown.

The support rail 300 can be configured to provide a mechanically balanced load bearing support. For example, in applications where the torque tube 314 is moved (e.g., swung) about an arc such that the torque tube 314 is moved about such arc that is offset from the central longitudinal axis of the torque tube 314, the support rail 300 can be configured to bear and transfer associated loading thereat in a mechanically balanced manner. For instance, in some applications the torque tube 314 can swing or slide about a rotational axis that is about a center of mass of the torque tube 314 rather than about a central longitudinal axis of the torque tube 314. The support rail 300 can include the first connecting member 321a and the second connecting member 321b extending out from the truss adapter 320 at locations about the truss adapter 320 that can be adapted to transfer loading from the torque tube 314 to ground supports via the first connecting member 321a and the second connecting member 321b in a mechanically balanced manner. As shown in FIGS. 5A to 9, a central longitudinal axis L₁ of the first connecting member 321a and a central longitudinal axis L₂ of the second connecting member 321b can intersect at the torque tube 314 (e.g., at a center of mass of the torque tube 314). In the embodiment shown here, the axes L₁ and L₂ can each extend through the sliding member 316 and intersect at the torque tube 314. The angle of the first connecting member 321a and the second connecting member 321b may match the intersection of loading (e.g., axial, radial), thereby evenly distributing the loading forces to various solar tracker components (e.g., truss supports, piers, piles, truss adapters, etc.), creating a mechanically balanced support rail 300.

FIG. 6A is a side-view of the support rail 300 and the truss adapter 320, including the torque tube 314. FIG. 6B is an isolated view of the truss adapter 320. As shown in FIG. 6B, the truss adapter 320 may include one or more rollers, e.g., a first roller 325a, a second roller 325b, a third roller 325c, and a fourth roller 325d, generally referred to herein as one or more rollers 325. While it is shown that there are four rollers 325, it may be contemplated that there may be one roller, two rollers, five rollers, eight rollers, or any other suitable number of rollers as desired. The one or more rollers 325 may be configured to ride within one or more guides, e.g., a first guide 344a or a second guide 344b, generally referred to herein as one or more guides 344. The one or more guides 344 may be positioned within the bottom side 348 of the support rail 300. In some examples, as the support rail 300 rotates to orient a solar module (e.g., solar module 12) as it tracks the movement of the sun, and while the truss adapter 320 may remain stationary, the one or more rollers 325 may “roll” within the one or more guides 344. In some examples, the support rail 300 may move arcuately along the one or more rollers 325 in one direction (e.g., west) until the bottom side 348 of the first end 341a abuts a first stop 322a of the truss adapter 320. Similarly, the support rail 300 may move arcuately along the one or more rollers 325 in another direction (e.g., east) until the bottom side 348 of the second end 341b abuts a second stop 322b of the truss adapter 320. The support rail 300 may move in an arcuate path along the one or more rollers 325 about 150-degrees from the first end 341a to the second end 341b. That is, the support rail 300 may move arcuately through 75-degrees in one direction, and 75-degrees in another direction.

FIG. 7A is an isolated view of the support rail 300 and the torque tube 314, and FIG. 7B is a cross-sectional view of the support rail 300 and the torque tube 314, taken at line 7B-7B. As discussed with reference to FIGS. 6A to 6B, the one or more rollers 325 may be configured to ride within the one or more guides 344, as shown by the second roller 325b and the fourth roller 325d positioned within the second guide 344b, in FIG. 7B. The one or more guides 344 may be positioned within the bottom side 348 of the support rail 300. The one or more guides 344 may be configured to move along an arcuate path in an east-west direction. As shown, the torque tube 314 is coupled to the support rail 300 via the engagement of the sliding member 316 with the receiving bracket 324. As such, when the support rail 300 moves in an arcuate path in the east-west (and/or west-east) direction, the torque tube 314 rotates with it.

FIG. 8 is an underside 313 view of the torque tube 314 showing the sliding member 316. The sliding member 316 may include the first end portion 315a, the second end portion 315b, and the middle portion 317 therebetween. The first end portion 315a and the second end portion 315b may each include a hooklike shape which may curve away from the top side 346 of the support rail 300, and the middle portion 317 may include a ridge-like protrusion, as shown in further detail with reference to FIG. 8. The sliding member 316 may be coupled to the torque tube 314 via welding, adhesives, mechanical fasteners, or any other suitable coupling mechanism as desired.

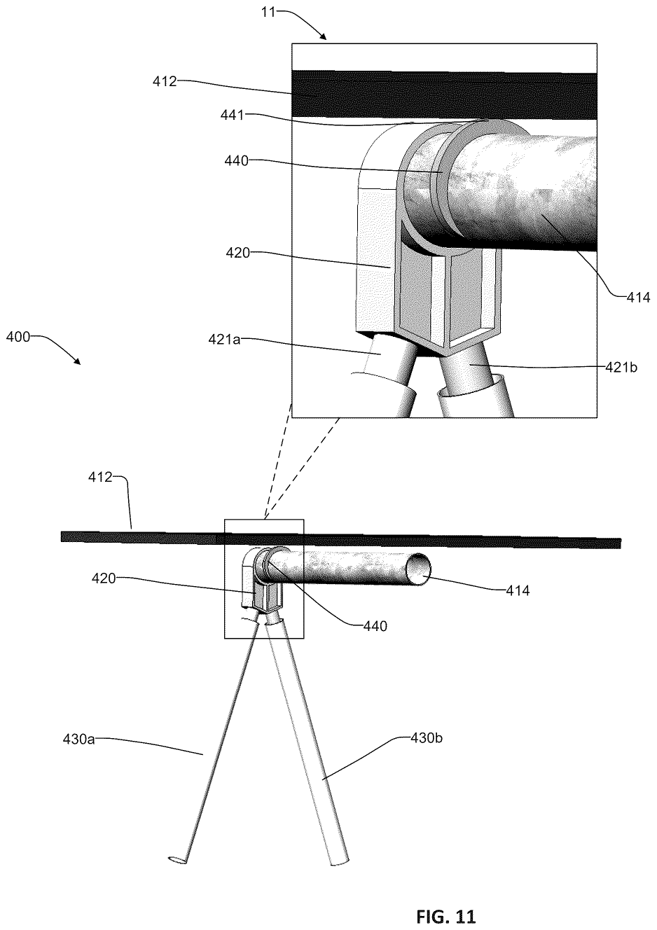

FIG. 9 is a front-side view of the support rail 300. The support rail 300 may include a curved “U-shape” having the first end 341a and the second end 341b, the first end 341a and the second end 341b defining the “U-shape” therebetween. The support rail 300 may further include the top side 346 and the bottom side 348, opposite the top side 346. In some examples, the receiving bracket 342 may be coupled to the top side 346 of the support rail 300. The receiving bracket 342 may include the first end portion 343a, the second end portion 343b, and the middle portion 345 therebetween. The first end portion 343a and the second end portion may each include hooklike shape which may curve inward toward the top side 346 of the support rail 300, and the middle portion 345 may include the channel. The receiving bracket 342 may be coupled to the support rail 300 via welding, adhesives, mechanical fasteners, or any other suitable coupling mechanism as desired.

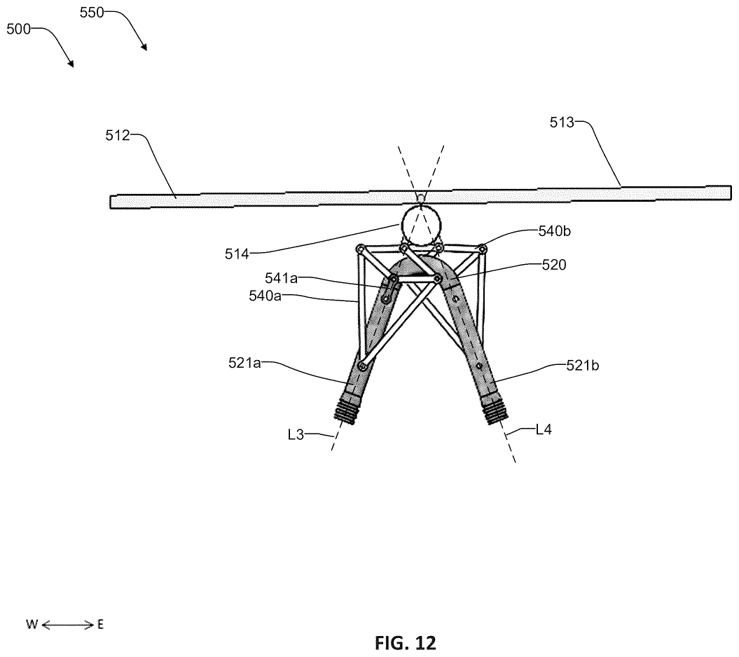

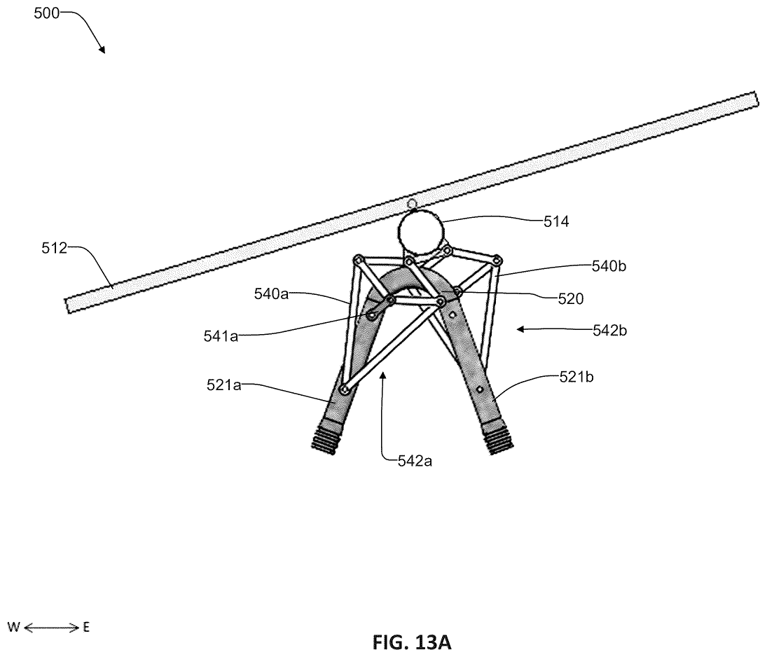

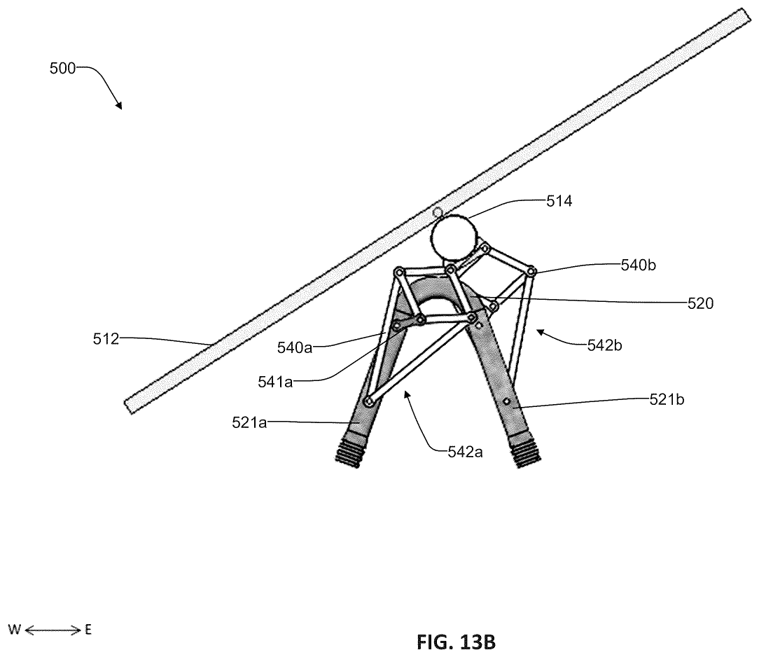

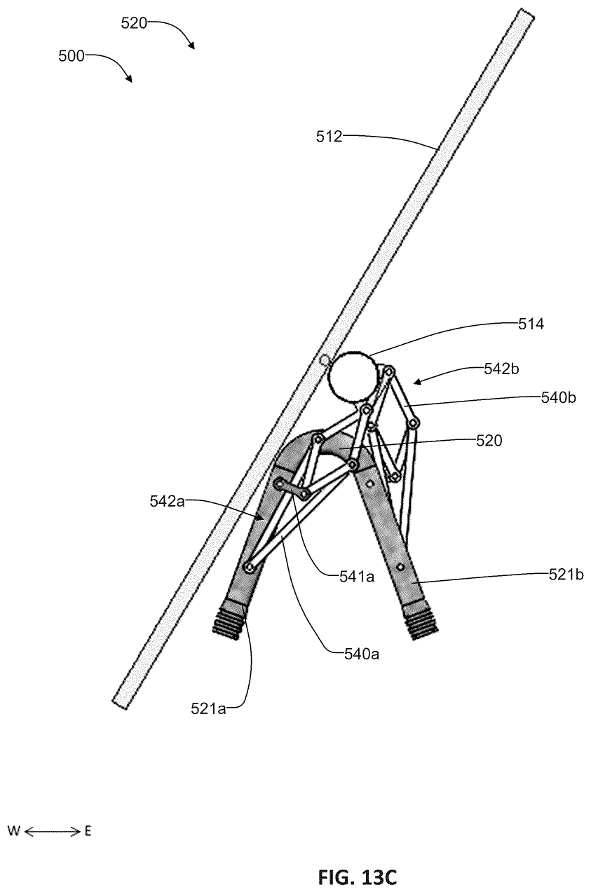

FIG. 10A is a front-side view of an example truss support 400 in a first position 450, FIG. 10B is a front-side view of the truss support 400 in a second position 452, FIG. 10C is a front-side view of the truss support 400 in a third position 454, and FIG. 11 is a perspective view of the truss support 400. As shown in FIGS. 10A to 11, the truss support 400 may include a first upper leg 430a, a second upper leg 430b, and a truss adapter 420. The first upper leg 430a and the second upper leg 430b may each be formed from a hollow, metal shaft having a substantially uniform diameter, and open at both ends, and although not explicitly shown, the first upper leg 430a and the second upper leg 430b may be adapted to be coupled to a first anchor and a second anchor, respectively, that may be embedded in the ground.

The truss adapter 420 may include a first connecting portion 421a and a second connecting portion 421b. The first upper leg 430a and the second upper leg 430b may be configured to be coupled to the truss adapter 420 by sleeving the first upper leg 430a and the second upper leg 430b over the first connecting portion 421a and the second connecting portion 421b, respectively. Then, crimps may be formed over the overlapping portion of each of the first upper leg 430a and the second upper leg 430b with the first connecting portion 421a and the second connecting portion 421b, respectively, to lock the truss adapter 420 into place, thereby forming a rigid, A-frame structure.

As shown in FIGS. 10A to 11, the truss support 400 may be configured to support a torque tube 414. In some examples, the truss adapter 420 may include a bearing housing assembly (BHA) positioned within the truss adapter 420. Further, a drive motor may be positioned within the truss adapter 420. The drive motor may be configured to rotate the torque tube 414 through an arc in an east-west (and/or west-east) direction. Further, a solar module 412 may be coupled to the torque tube 414 via one or more brackets. The solar module 412 may include a front surface 413 configured to face the sun and may hold a plurality of photovoltaic cells (not explicitly shown) which are configured to receive the light from the sun and generate a voltage when solar radiation is passed through the front surface 413. The solar module 412 may be an example of solar module 12, as in FIG. 1.

The truss support 400 may further include a first spring 435a, a second spring 435b, and a cam 440. In some examples, the cam 440 may include an asymmetric profile and may be configured to be coupled to the torque tube 414, as shown in FIG. 11. The cam 440 may be coupled to the torque tube 414 via friction fit, welding, adhesives, mechanical fasteners, or the like. The first spring 435a may include a first end 436a, which may be configured to be coupled to a peak 441 of the cam 440 (peak 441 shown in Square 11 of FIG. 11). Similarly, the second spring 435b may include a first end 436b that may also be configured to be coupled to the peak 441 of the cam 440. In some examples, the first end 436a of the first spring 435a maybe positioned adjacent the first end 436b of the second spring 435b. In other examples, the first end 436a of the first spring 435a may overlap with the first end 436b of the second spring 435b. The first end 436a of the first spring 435a and the first end 436b of the second spring 435b may each be coupled to the peak 441 of the cam 440 via welding, adhesives, mechanical fasteners, or the like. In examples where the first end 436a of the first spring 435a overlaps with the first end 436b of the second spring 435b, the first end 436a and the first end 436b may be further coupled to one another.

The first spring 435a may further include a second end 437a that may be configured to be coupled to the first upper leg 430a. In some examples, the second end 437a of the first spring 435a may be coupled to the first upper leg 430a in an upper region, a middle region, or a lower region of the first upper leg 430a, or in any region along the first upper leg 430a as so desired. Similarly, the second spring 435b may further include a second end 437b that may be configured to be coupled to the second upper leg 430b. In some examples, the second end 437b of the second spring 435b may be coupled to the second upper leg 430b in an upper region, a middle region, or a lower region of the second upper leg 430b, or in any region along the second upper leg 430b as so desired. In some examples, as shown in FIG. 10A, the second end 437a of the first spring 435a may be coupled to the first upper leg 430a via a first spring fastener 438a. The first spring fastener 438a may be configured to extend around an outer circumference of the first upper leg 430a. In some examples, the first spring fastener 438a may be formed as part of the first upper leg 430a. In such cases, the second end 437a of the first spring 435a may couple to the first spring fastener 438a via a mechanical fastener, welding, adhesives, or the like. In some examples, the first spring fastener 438a may be formed as part of the second end 437a of the first spring 435a and may extend around the first upper leg 430a. In such cases, the first spring fastener 438a may extend around the first upper leg 430a and may maintain its position via friction fit, welding, adhesives, or the like. In some examples, as shown in FIGS. 10B to 10C, the first spring fastener 438a may not be included, and the second end 437a of the first spring 435a may be coupled directly to the first upper leg 430a via welding, adhesives, or the like. It will be appreciated that the description of the second end 437a and the first spring fastener 438a of the first spring 435a further apply to the second end 437b and a second spring fastener 438b of the second spring 435b.

FIG. 10B shows the truss support 400 in the second position 452, in which the solar module 412 may be in a westward facing position. As shown, a force from the rotation of the torque tube 414, and thereby the cam 440 (as the cam 440 rotates with the torque tube 414), in addition to the weight of the solar module 412, may be applied to the first spring 435a, thereby compressing the first spring 435a. The same force may be applied to the second spring 435b, however, rather than compressing the second spring 435b, the second spring 435b may be extended (e.g., stretched in tension). The spring force of each of the first spring 435a and the second spring 435b work together to aid in controlling the rotation of the solar module 412. The shape of the cam 440 may change the leverage of the first spring 435a and the second spring 435b in a way that balances out three forces being applied to the truss support 400. The three forces being applied may be gravity, which may depend upon the angle of rotation, the spring force of the first spring 435a and the spring force of the second spring 435b.

FIG. 10C shows the truss support 400 in the third position 454, in which the solar module 412 may be in an eastward facing position. As shown, a force from the rotation of the torque tube 414, and thereby the cam 440 (as the cam 440 rotates with the torque tube 414), in addition to the weight of the solar module 412, may be applied to the second spring 435b, thereby compressing the second spring 435b. The same force may be applied to the first spring 435a, however, rather than compressing the first spring 435a, the first spring 435a may be extended (e.g., stretched in tension). The spring force of each of the first spring 435a and the second spring 435b work together to aid in controlling the rotation of the solar module 412.

The spring force of the first spring 435a and the spring force of the second spring 435b may work to balance the force exerted by gravity. However, both the first spring 435a and the second spring 435b may always be in tension. For example, when the first spring 435a and the second spring 435b are in tension, the first spring 435a and the second spring 435b exert an off-center force, and therefore a torque, on the torque tube 414. Torque calculated as the force (from the springs 435a, 435b) multiplied by the radius from the center of rotation. Gravity exerts a torque, and the first spring 435a and the second spring 435b in tension exert a torque. In cases when the solar module 412 is at horizontal, the torque exerted by gravity is zero. As the torque tube 414 rotates away from horizontal, the torque due to gravity increases, the torque due to the compressed spring (e.g., first spring 435a in FIG. 10B, second spring 435b in FIG. 10C) decreases, and the torque due to the extension of the spring (e.g., second spring 435b in FIG. 10B, first spring 435a in FIG. 10C) increases. The torques may be balanced by increasing the radius of the lever arm on the side of the extended spring (e.g., second spring 435b in FIG. 10B, first spring 435a in FIG. 10C). This increasing radius may be the cam 440.

FIG. 11 shows the truss support 400 without the first spring 435a and the second spring 435b to more clearly show the cam 440 coupled to the torque tube 414. As previously stated, the cam 440 may include an asymmetric profile (e.g., asymmetric longitudinal cross-sectional profile) and may be configured to be coupled to the torque tube 414, as shown in FIG. 11. The cam 440 may be coupled to the torque tube 414 via friction fit, welding, adhesives, mechanical fasteners, or the like. The shape of the cam 440 may change the leverage of the first spring 435a and the second spring 435b in a way that balances out three forces being applied to the truss support 400. The three forces being applied may be gravity, which may depend upon the angle of rotation, the spring force of the first spring 435a and the spring force of the second spring 435b. The use of the cam 440 and the first spring 435a and the second spring 435b together may reduce the force (e.g., stress) placed upon a drive motor configured to rotate the torque tube 414.

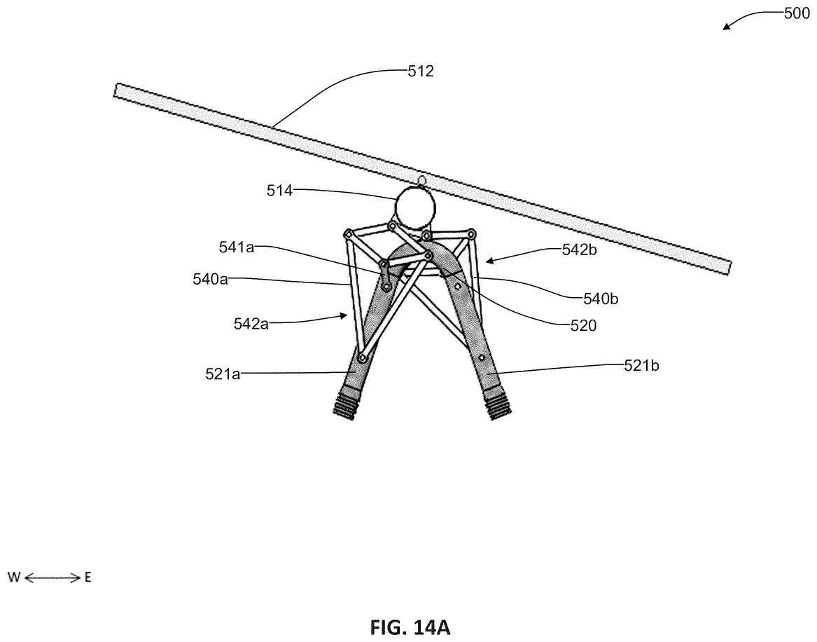

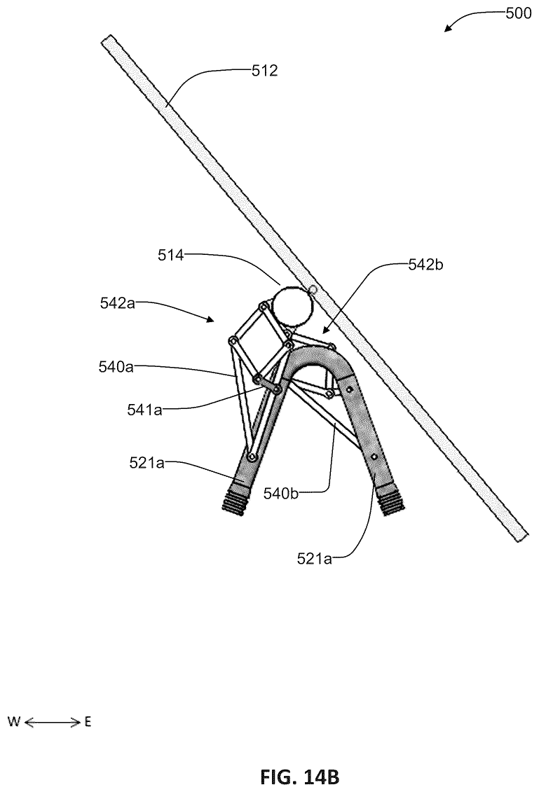

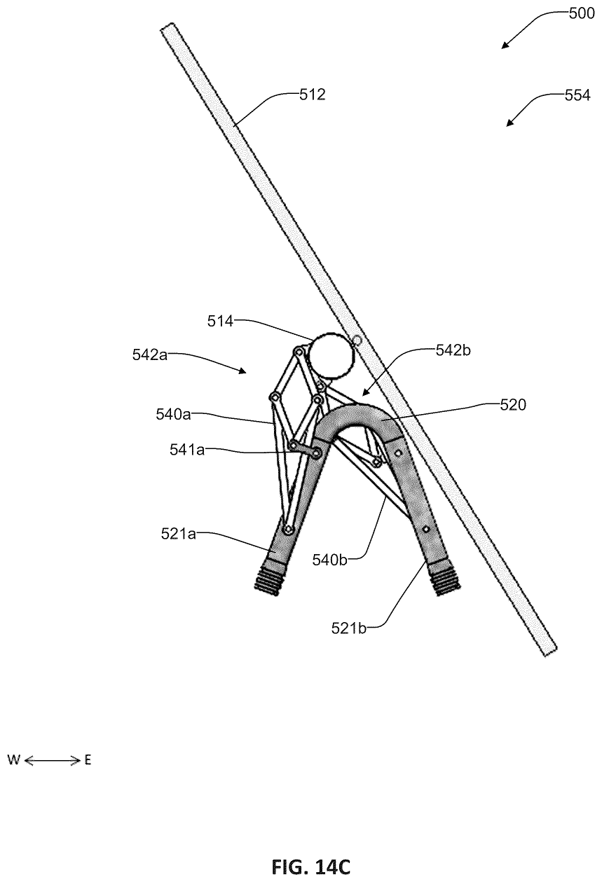

FIG. 12 is a front-side view of an example truss support 500 in a first position 550, FIGS. 13A to 13C illustrate the example truss support 500 moving to a second position 552, and FIGS. 14A to 14C illustrate the example truss support 500 moving to a third position 554. As shown in FIGS. 12 to 14C, the truss support 500 may include a truss adapter 520 having a first connecting portion 521a and a second connecting portion 521b. Although not explicitly shown in FIGS. 12 to 14C, the truss adapter 520 may be configured to be attached to a pair of truss legs that may be coupled to a first anchor and a second anchor, respectively, that may be embedded in the ground. Further, as shown in FIGS. 12 to 14C, the truss support 500 may be a Peaucellier Mechanism that may include a first multi-linked pivoting leg 540a and a second multi-linked pivoting leg 540b, generally referred to herein as first pivoting leg 540a and second pivoting leg 540b. The combination of the first pivoting leg 540a and the second pivoting leg 540b work together to define an arcuate path of the torque tube 514 and the solar module 512 about a virtual axis at a center of mass.

As shown in FIGS. 12 to 14C, the truss support 500 may be configured to support a torque tube 514. In some examples, the truss adapter 520 may include a bearing housing assembly (BHA) positioned within the truss adapter 520. Further, a drive motor may be positioned within the truss adapter 520. The drive motor may be configured to rotate the torque tube 514 through an arc in an east-west (and/or west-east) direction. Further, a solar module 512 may be coupled to the torque tube 514 via one or more brackets. The solar module 512 may include a front surface 513 configured to face the sun and may hold a plurality of photovoltaic cells (not explicitly shown) which are configured to receive the light from the sun and generate a voltage when solar radiation is passed through the front surface 513. The solar module 512 may be an example of solar module 12, as in FIG. 1.

As shown in FIGS. 13A to 13C, the truss support 500 may be moving to the second position 552, in which the solar module 512 may be in a westward facing position, and FIGS. 14A to 14C show the truss support 500 moving to the third position 554, in which the solar module 512 may be in an eastward facing position. As shown, the first pivoting leg 540a may include a first plurality of linked portions 542a coupled to a first fixed point 541a. In some examples, the first plurality of linked portions 542a of the first pivoting leg 540a may rotate about the first fixed point 541a as the torque tube 514 rotates. The plurality of linked portions 542a may absorb a force applied as the torque tube 514 rotates, thereby reducing the force (e.g., stress) placed upon a drive motor configured to rotate the torque tube 514. It will be appreciated that the description of the first pivoting leg 540a further applies to the second pivoting leg 540b. The first pivoting leg 540a and the second pivoting leg 540b may work together to aid in controlling the rotation of the solar module 512.

The truss support 500 shown in FIGS. 12 to 14C can be configured to provide a mechanically balanced load bearing support. For example, in applications where the torque tube 514 is moved (e.g., swung) about an arc such that the torque tube 514 is moved about such arc that is offset from the central longitudinal axis of the torque tube 514, the truss support 500 can be configured to bear and transfer associated loading thereat in a mechanically balanced manner. For instance, in some applications the torque tube 514 can swing about a rotational axis that is about a center of mass of the torque tube 514 rather than about a central longitudinal axis of the torque tube 514. The truss adapter 520 can include the first connecting member 521a and the second connecting member 521b extending out from the truss adapter 520 at locations about the truss adapter 520 that can be adapted to transfer loading from the torque tube 514 to ground supports via the first connecting member 521a and the second connecting member 521b in a mechanically balanced manner. As shown in FIGS. 12 to 14C, a central longitudinal axis L₃ of the first connecting member 521a and a central longitudinal axis L₄ of the second connecting member 521b can intersect at the torque tube 514 (e.g., at a center of mass of the torque tube 514). In the embodiment shown here, the axes L₃ and L₄ can each extend through one or more of the links of the pivoting leg 540 and intersect at the torque tube 514. The angle of the first connecting member 521a and the second connecting member 521b may match the intersection of loading (e.g., axial, radial), thereby evenly distributing the loading forces to various solar tracker components (e.g., truss supports, piers, piles, truss adapters, etc.), creating a mechanically balanced truss support 500.

Various non-limiting exemplary embodiments have been described. It will be appreciated that suitable alternatives are possible without departing from the scope of the examples described herein.

What is claimed is:

1. A solar tracker support assembly comprising:
a sliding member coupled to a torque tube;
a support rail comprising a receiving bracket, the sliding member slidably coupled to the receiving bracket such that the torque tube is slidable relative to the support rail; and
a truss adapter configured to couple the support rail to a solar tracker foundation.

2. The assembly of claim 1, wherein the coupling of the sliding member and the receiving bracket slidingly and rotationally supports the torque tube relative to the truss adapter.

3. The assembly of claim 2, wherein the support rail is rotationally coupled to the truss adapter such that the support rail is rotatable with the torque tube relative to the truss adapter.

4. The assembly of claim 3, wherein the torque tube is configured to support one or more solar modules at a first side of the torque tube, and wherein the sliding member, support rail, and receiving bracket are each located at least opposite the first side of the torque tube.

5. The assembly of claim 4, wherein the torque tube is rotatable relative to truss adapter about a rotational axis that is different than a central longitudinal axis of the torque tube.

6. The assembly of claim 2, wherein the coupling of the sliding member and the receiving bracket slidingly supports the torque tube relative to the truss adapter such that the torque tube can slide relative to the truss adapter in a north-south direction.

7. The assembly of claim 1,
wherein the truss adapter comprises one or more rollers,
wherein the support rail comprises one or more roller guides, and
wherein the truss adapter rotatably supports the support rail to rotate relative to the truss adapter via engagement of the one or more rollers at the one or more roller guides.

8. The assembly of claim 7, wherein the support rail is rotatable relative to the truss adapter in an arcuate path in an east-west direction.

9. The assembly of claim 8, wherein the support rail is configured to rotate relative to the truss adapter in the arcuate path in an east direction until the support rail contacts a first stop at the truss adapter, and wherein the support rail is configured to rotate relative to the truss adapter in the arcuate path in a west direction until the support rail contacts a second stop at the truss adapter.

10. The assembly of claim 8,
wherein the coupling of the sliding member and the receiving bracket slidingly supports the torque tube relative to the truss adapter, and
wherein the coupling of the sliding member and the receiving bracket rotationally couples the torque tube to the support rail such that as the torque tube is driven to rotate the support rail rotates with the torque tube in the arcuate path in the east-west direction.

11. The assembly of claim 1,
wherein the sliding member comprises a first sliding member end portion, a second sliding member end portion, and a protruded sliding member middle portion between the first and second sliding member end portions,
wherein the receiving bracket comprises a first receiving bracket end portion, a second receiving bracket end portion, and a channeled receiving bracket middle portion between the first and second receiving bracket end portions, and
wherein the torque tube is slidably and rotationally coupled to the support rail via engagement of the first sliding member end portion at the first receiving bracket end portion, engagement of the second sliding member end portion at the second receiving bracket end portion, and engagement of the protruded sliding member middle portion at the channeled receiving bracket middle portion.

12. The assembly of claim 11, wherein the first receiving bracket end portion extends over the first sliding member end portion, wherein the second receiving bracket end portion extends over the second sliding member end portion, and wherein a protrusion at the protruded sliding member middle portion is received at a channel at the channeled receiving bracket middle portion.

13. A solar tracker support assembly comprising:
a first truss leg;
a second truss leg;
a truss adapter comprising a first connecting portion connected to the first truss leg and a second connecting portion connected to the second truss leg;
a cam configured to couple to a torque tube to the truss adapter;
a first spring comprising a first spring first end connected to the cam and a first spring second end connected to the first truss leg; and
a second spring comprising a second spring first end connected to the cam and a second spring second end connected to the second truss leg.

14. The assembly of claim 13, wherein the cam is configured to rotate with the torque tube to orient at least one solar module in an eastward facing orientation, and wherein when the at least one solar module is in the eastward facing orientation the first spring is compressed while the second spring is tensioned.

15. The assembly of claim 14, wherein the cam is configured to rotate with the torque tube to orient at least one solar module in a westward facing orientation, and wherein when the at least one solar module is in the westward facing orientation the first spring is tensioned while the second spring is compressed.

16. The assembly of claim 15, wherein the cam comprises an asymmetric cross-sectional profile.

17. The assembly of claim 16, wherein the torque tube is at least partially received within the cam.

18. The assembly of claim 17, wherein the first spring first end is connected to the cam above the torque tube, and wherein the second spring first end is connected to the cam above the torque tube.

19. The assembly of claim 18, wherein the first spring first end and the second spring first end overlap at the cam above the torque tube.

20. The assembly of claim 16, wherein the asymmetric cross-sectional profile of the cam is configured to transfer gravitational forces in multiple axes to the first spring and the second spring.
